(19) United States
(12) Patent Application Publication
(10) Pub. No.: US 2012/0112694 A1
(43) Pub. Date: May 10, 2012

(54) Method and Arrangement for Data Communication Between A Service Provider and A Vehicle

(75) Inventors: Thomas Frisch, Boeblingen (DE); Michael Koehler, Brandenburg (DE); Holger Lochner, Ludwigsburg (DE); Christoph Saalfeld, Stuttgart (DE); Tim Schluesener, Stuttgart (DE)

(73) Assignee: Daimler AG, Stuggart (DE)

(21) Appl. No.: 13/318,421

(22) PCT Filed: Apr. 23, 2010
(86) PCT No.: PCT/EP2010/002503

§ 371 Date: Dec. 12, 2011

(30) Foreign Application Priority Data
May 2, 2009 (DE) 10 2009 019 753.2

(51) Int. Cl. H02J 7/00

(52) U.S. Cl. 320/109

(57) ABSTRACT

A method and an arrangement for data communication between a service provider and a vehicle having an electric drive are provided. A communication connection can be established between the vehicle and the service provider via a first wireless connection. When the vehicle is connected to a charging station via a charging connection for charging an accumulator provided in the vehicle, a further communication connection is established between the vehicle and the service provider via the charging station.

### BACKGROUND AND SUMMARY OF THE INVENTION

The invention relates to a method for data communication between a service provider and a vehicle having an electric drive.

Modern vehicles, particularly electric vehicles and hybrid vehicles, frequently have a wireless interface for data communication, over which telematic services can be supplied.

German Patent Document No. DE 10 2008 022 771 A1 discloses a method and system for transmitting vehicle diagnostic data to a vehicle service provider. In this case, sensors are used for producing sensor signals indicating the status or integrity of vehicle components. A diagnostic module in the vehicle produces diagnostic data based on the sensor signals and transmits the diagnostic data to a communication module of a hands-free phone system in the vehicle. The communication module transmits the diagnostic data using Bluetooth communication wirelessly to a Bluetooth-capable cell phone. The cell phone transmits the diagnostic data via the Internet to an Internet server, in order to establish whether one of the vehicle components needs repairing or servicing. The service provider informs a user of the vehicle about a vehicle component, which needs repairing or servicing.

U.S. Patent Application Publication No. US 2009/0021385 A1 discloses a method for communicating with an electric vehicle. The method includes a step of installing a communication device in the vehicle. Also a connection from the vehicle to a network is established and a battery in the electric vehicle is controlled and monitored.

An object of the invention is to indicate an improved method and an improved device for data communication between a vehicle and a service provider.

In one inventive method for data communication between a service provider and a vehicle having an electric drive, a communication connection can be established between the vehicle and the service provider via a first wireless connection. When the vehicle is connected to the charging station via a charging connection for charging an accumulator provided in the vehicle, a further communication connection is established between the vehicle and the service provider via the charging station.

Due to the short distance between vehicle and charging station this data connection can be established more reliably and with higher bandwidth than the first wireless connection, which is usually in the form of a cell phone connection. In addition, lower connection costs arise through the connection via the charging station than through the cell phone connection and supply of voltage by the charging station is guaranteed in every case, even if the vehicle/engine is stationary. Likewise accessibility of the parking vehicle is better guaranteed via the charging station than via a cell phone connection, particularly in an underground parking garage. Also as a result of the high potential bandwidth, services with high data rate are possible, such as audio and video streams. The high robustness and availability of the connection with low probability of interruption permit services such as software-/firmware-updates of vehicle or infotainment components (control units, computers), which, if interrupted, would have serious consequences. This is particularly possible in a safe way, since it is ensured that the vehicle is not in circulation during the charging operation. The user can order software-updates or other services from the service provider via the first wireless connection.

Vehicles having an electric drive in the sense of the present invention are understood to mean both pure electric vehicles and so-called plug-in hybrids, which can be connected to a charging station in order to charge the accumulator.

The communication connection to the charging station can be established via the charging connection or via a separate connection, even a second wireless connection.

Preferably a wire-bound connection is used as charging connection. However an inductive connection is also conceivable. The communication connection is established on the charging connection preferably by means of a power line communication (PLC) device. Here communication signals are modulated onto a power supply line so that this can be used more than once.

The first and/or second wireless connection in each case can be in the form of a cell phone connection and/or a Bluetooth connection and/or an Ethernet connection. Particularly, however, the first wireless connection is a cell phone connection and the second wireless connection is a Bluetooth connection or an Ethernet connection (for example WLAN).

Preferably an application server, in which data exchange is amalgamated, coordinated and its status monitored via the first wireless communication connection and via the communication connection via the charging station and over which the services offered by the service provider are supplied, is located at the service provider. The application server can be connected via the Internet to the charging station.

Particularly at least one of the services: diagnosis, maintenance, vehicle configuration, selection of a charging option, time of next use, authentication of functions, pre-conditioning of the vehicle, remote software-update of vehicle functions or infotainment systems, synchronizing or updating user data or data of a navigation system and/or a directory and/or a calendar, transmission of audio and/or video data, Internet, telephony, remote emission measurement is made available via the data communication or the application server. The charging can be, for example, high-speed charging, economy charging or battery-saving charging. Pre-conditioning of the vehicle can be understood to mean comfort functions such as independent air-conditioning or heating for example.

Data communication can take place uni-directionally or bi-directionally.

Preferably a further communication connection is established with an energy supplier via the charging connection, for example in order to collect payment for the energy consumed irrespective of the place where the charging station is located (public or private).

### BRIEF DESCRIPTION OF THE DRAWING FIGURE

An exemplary embodiment of the invention is described in detail below on the basis of a drawing, wherein.

FIG. 1 shows an arrangement for data communication between a service provider and a vehicle having an electric drive.

### DETAILED DESCRIPTION

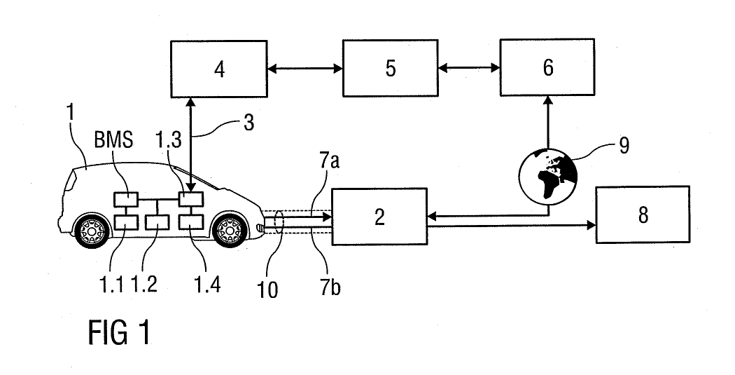

FIG. 1 illustrates an arrangement for data communication between a service provider and a vehicle 1 having an electric drive.

Vehicles 1 having an electric drive in the sense of the present invention are generally understood to include both pure electric vehicles and so-called plug-in hybrids, which can be connected to a charging station 2 in order to charge an accumulator 1.1 of the vehicle via a charging circuit 1.2, which serves to supply the electric drive.

The vehicle has means 1.3 (communication unit) for establishing a communication connection via a first wireless connection 3. This is a point-to-point connection between the vehicle 1 and a cell terminal 4. Direct data exchange can take place via this connection.

A customer 5 or an original equipment manufacturer (OEM) has access to the phone terminal 4 and to an application server 6 located at the service provider. Data exchange between vehicle 1 and phone terminal 4 is bi-directional and based for example on a cell phone connection, a Bluetooth connection or an Ethernet connection (preferably WLAN).

For charging at the charging station 2, a charging connection 10 is established between vehicle 1 and charging station 2. This charging connection 10, by way of power line communication (PLC), is also used as communication connection 7a, 7b. For this purpose, a power line communication device 1.4 for modulation/demodulation is provided in the vehicle. A further power line communication device is arranged in the charging station 2 (not illustrated).

The charging station 2 is connected to an energy supplier 8, both for procuring the energy necessary for charging and also for transmitting data, for example in order to collect payment for the energy consumed. Moreover the charging station 2 is connected to the Internet 9 by means of DSL, GPRS or other data communication service.

The application server 6 communicates in this way with the vehicle 1 both via the first wireless connection 3 and via the communication connection 7a (end-to-end communication, tunnelling of data between vehicle 1 and application server 6).

The communication connection 7a, 7b to the charging station 2 can be established via the charging connection 10 or via a separate connection, even a second wireless connection.

The charging connection 10 can be a wire-bound connection or an inductive connection.

The first wireless connection 3 and/or second wireless connection in each case can be in the form of a cell phone connection and/or a Bluetooth connection and/or an Ethernet connection.

Particularly at least one of the services: diagnosis, maintenance, vehicle configuration, selection of a charging option, time of next use, authentication of functions, pre-conditioning of the vehicle, remote software-update of vehicle functions or infotainment systems, synchronizing or updating user data or data of a navigation system and/or a directory and/or a calendar, transmission of audio and/or video data, Internet, telephony, remote emission measurement can be made available via the data communication or the application server 6. The charging options can be include, for example, high-speed charging, economy charging or battery-saving charging may be proposed. Pre-conditioning of the vehicle can be understood to mean comfort functions such as independent air-conditioning or heating for example.

Data communication can take place uni-directionally or bi-directionally via each of the connections 3, 7a, 7b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for data communication between a service provider and a vehicle having an electric drive, the method comprising:
establishing a communication connection between the vehicle and the service provider via a first wireless connection;
connecting the vehicle having the electric drive to a charging station via a charging connection for charging an accumulator provided in the vehicle;
establishing a further communication connection the vehicle and the service provider via the charging station; and
performing a data exchange with an application server located at the service provider, wherein the data exchange is amalgamated and coordinated via the first wireless connection and via the communication connection over the charging station.

12. The method according to claim 11, wherein the communication connection to the charging station is established via the charging connection.

13. The method according to claim 11, wherein the data communication or the application server makes available at least one of the services:
diagnosis,
maintenance,
vehicle configuration,
selection of a charging option,
time of next use,
authentication of functions,
pre-conditioning of the vehicle,
remote software-update of vehicle functions or infotainment systems,
synchronizing or updating data of a navigation system, a directory or a calendar,
transmission of audio, video or audio/video data,
Internet access,
telephony, and
remote emission measurement.

14. The method according to claim 11, wherein data communication is unidirectional.

15. The method according to claim 11, wherein data communication is bidirectional.

16. The method according to claim 11, further comprising:
establishing another communication connection with an energy supplier via the charging connection.

17. The method according to claim 11, wherein the application server is connected to the charging station via the Internet.

18. An arrangement for data communication between a service provider and a vehicle having an electric drive, comprising:
means for establishing a communication connection between the vehicle and the service provider via a first wireless connection;
means for establishing a further communication connection via a charging station, at which an accumulator provided in the vehicle can be recharged via a charging connection,
wherein an application server is located at the service provider, by means of which data exchange can be amalgamated and coordinated via the first wireless communication connection and via the communication connection over the charging station.

19. The arrangement according to claim 18, wherein the communication connection to the charging station is established via the charging connection.

20. The arrangement according to claim 18, wherein the application server is connectable to the charging station via the Internet.

21. The arrangement according to claim 18, wherein the data communication or the application server makes available at least one of the services:
diagnosis,
maintenance,
vehicle configuration,
selection of a charging option,
time of next use,
authentication of functions,
pre-conditioning of the vehicle,
remote software-update of vehicle functions or infotainment systems,
synchronizing or updating data of a navigation system, a directory or a calendar,
transmission of audio, video or audio/video data,
Internet access,
telephony, and
remote emission measurement.
